(19) United States
(12) Patent Application Publication
(10) Pub. No.: US 2006/0289403 A1
(43) Pub. Date: Dec. 28, 2006

(54) Method and apparatus for the creation and utilization of hydrogen ordering materials (hydrom)

(76) Inventor: Andre Jouanneau, Potomac, MD (US)

Correspondence Address: BERENATO, WHITE & STAVISH, LLC, 6550 ROCK SPRING DRIVE, SUITE 240, BETHESDA, MD, 20817, US

(21) Appl. No.: 11/499,758

(22) Filed: Aug. 7, 2006

Related U.S. Application Data
(63) Continuation-in-part of application No. 11/004,233, filed on Dec. 6, 2004.
(60) Provisional application No. 60/560,012, filed on Apr. 7, 2004.

(51) Int. Cl. B23K 9/00; B23K 9/02

(52) U.S. Cl. 219/121.44

(57) ABSTRACT

A hydrogen ordering material is provided. The hydrogen ordering material includes a metal having a lattice of metallic atoms forming elementary cells, and at least one hydrogen atom bound to the metallic atoms of the elementary cells to consume a portion of the elementary cells and establish a residual available space having a volume approximately equal to the volume of a free hydrogen atom. Also provided are methods of making and using the hydrogen ordering material, and apparatus containing the hydrogen ordering material.

### CROSS REFERENCE TO RELATED APPLICATIONS

This application is a continuation-in-part of U.S. patent application Ser. No. 11/004,233 filed on Dec. 6, 2004, the complete disclosure of which is incorporated herein by reference in its entirety, which claims the benefit of priority of provisional application 60/560,012 filed Apr. 7, 2004, the complete disclosure of which is incorporated herein by reference.

This application claims the benefit of priority under 35 U.S.C. § 119(e) of provisional application 60/705,439 filed Aug. 5, 2005 entitled “Method and apparatus for the creation and utilization of hydrogen ordering materials (hydrom),” the complete disclosure of which is incorporated herein by reference, and provisional application 60/560,012 filed Apr. 7, 2004, the complete disclosure of which is incorporated herein by reference.

### FIELD OF THE INVENTION

This invention generally relates to the storage and production of energy. The hydrogen ordering materials (hydrom) have many potential applications including but not limited to production and use of plasma solid, thermonuclear fusion, storage of energy, storage of hydrogen, catalytic property, fuel cell, superconductivity, etc.

### BACKGROUND OF THE INVENTION

Because there are no high efficiency, high capacity means to store electricity, the power supply on an electric grid is matched to demand at all times to prevent blackout. If, however, energy could be widely stored in a distributed fashion, and released cheaply and efficiently when needed, the reliability and security of the power grid would be increased tremendously. A significant proportion of the electricity produced by eco-friendly methods (e.g., wind, sun power, sea waves energy) is often wasted because the production frequently reaches the grid when the energy is not needed or when the energy cannot be safely distributed. If, instead, that wasted energy could be stored, the energy could then be converted back and distributed where and when the energy is needed on the grid. The plasma solid of embodiments of this invention constitutes a means to store large quantities of high density energy cheaply and efficiently. This energy can then be easily released and distributed into the grid.

Likewise, over the last decades, physicists have undertaken a massive effort to produce electric power through controlled nuclear fusion. Deuterium, which represents 0.015% of the hydrogen on earth, can be used as a fuel for nuclear fusion. Scientific research has been focused on the field of controlled high temperature plasma. High temperature plasmas are controlled through different means, including magnetic confinement of the plasma as in the case of the tokamak; a conventional mirror; a tandem mirror; or inertial confinement fusion by lasers or beams of protons. Despite massive investments in these very sophisticated apparatus, none of these methods have produced the excess of energy needed to sustain a continuous process of nuclear fusion.

The continuous increase in the concentration of carbon dioxide in the earth's atmosphere is very polluting. This increase in CO₂ is also thought to be the cause of an elevation in the earth's temperature through the green house effect. To prevent further deterioration in the earth's environment, a vast array of substitutes to the highly polluting combustion of fossil fuels has been considered. Despite their many technological and cost drawbacks, fuel cells are one of the most promising avenues of research. The use of the hydroms described in this application could easily and cheaply resolve most of the difficult technological problems which prevent the widespread use of fuel cells.

### SUMMARY OF THE INVENTION

In accordance with the purposes of the invention as broadly described in this document, an aspect of the invention provides a method of producing hydrogen ordering materials. These materials comprise elementary cells which are divided in a plurality of sections, preferably two sections. The first section is occupied by one or more hydrogen atoms bound to the metal atoms of the lattice. The number of hydrogen atoms bound to metal atoms of the cell depends on the nature of the metal. The remaining free space inside the elementary cell (second section) has a volume about the size of a free hydrogen atom. This arrangement is reproduced in a plurality of elementary cells, preferably in each and every elementary cell. The material constitutes an interconnected tri-dimensional network of elementary free spaces, each about the size of a free hydrogen atom. Because of this unique structure, free hydrogen atoms can easily move in orderly manner into and within the hydrogen ordering materials. The hydrogen ordering materials will henceforth be referred to as H.O.M. or hydroms. Hydroms have the special property of spatially and structurally ordering both the hydrogen atoms bound inside the cells and the flows of freely moving hydrogen atoms.

According to a second aspect of the invention, a method is provided of producing hydrogen ordering materials, the method comprising steps of providing a metal having a lattice of metallic atoms forming elementary cells, and binding at least one hydrogen atom to the metallic atoms of the elementary cells to consume a portion of the elementary cells and establish a residual space with a volume approximately equal to the volume of a free hydrogen atom.

According to another aspect of the inventions hydrogen ordering material or a hydrom is provided. The hydrom comprises a metal having a lattice of metallic atoms forming elementary cells, and at least one hydrogen atom bound to the metallic atoms of the elementary cells to consume a portion of the elementary cells and establish a residual available space having a residual space with a volume approximately equal to the volume of a free hydrogen atom.

According to another aspect of the invention, a method of using the hydrom is provided.

According to still another aspect of the invention, an apparatus, such as a fuel cell, comprising one or more hydroms is provided.

According to a further aspect of the invention, a method of using the apparatus (e.g., fuel cell) of one or more hydroms is provided.

Still other aspects of the invention relate to systems and additional methods comprising or making use of one or more hydroms.

### BRIEF DESCRIPTIONS OF THE DRAWINGS

The accompanying drawings are incorporated in and constitute a part of the specification. The drawings, together with the general description given above and the detailed description of the preferred embodiments and preferred methods given below, serve to explain the principles of the invention. In such drawings:

FIG. 1 shows an electrolytic bath for the electrochemical mechanism of hydrogen and the loading of hydrogen in a solid.

FIG. 2 represents the electrochemical mechanism of hydrogen inside a cathode;

FIG. 3 represents a diagram of potential as a function of Log i;

FIG. 4 illustrates the relationship between Log i₀ and the volume apparent Va for different metals;

FIG. 5a shows the potential as a function of Log i for the palladium in acid solution;

FIG. 5b represents the curve V=f(Log i) for palladium, with smooth and ruptured palladium electrodes;

FIG. 6a shows an elementary energy cell inside palladium;

FIG. 6b shows an elementary plasma cell inside palladium;

FIG. 7 illustrates the relationship between the time interval t₂ for the release of hydrogen and the apparent atomic volume Va of the alloys;

FIG. 8 represents a diagram of the apparent atomic volume Va of the hydroms as a function of the Pauling's electronegativity of the hydroms; and

FIG. 9 shows a diagram of a fuel cell using a hydrom as cathode.

### DETAILED DESCRIPTION OF PREFERRED EMBODIMENT AND PREFERRED METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

I. Solid and Nature of Plasma Creation

According to embodiments of the invention, storage of hydrogen can be created inside metallic materials from an ionic solution, a plasma gas, or a gas atmosphere. In the case of an ionic solution, the method is preferably electrochemical. The H⁺. D⁺ or T⁺ of the solution, submitted to an electrical field, penetrate inside the solid. These ions will be collectively referred to herein as HDT⁺.

I.A. Electrochemical Mechanism of Hydrogen Production

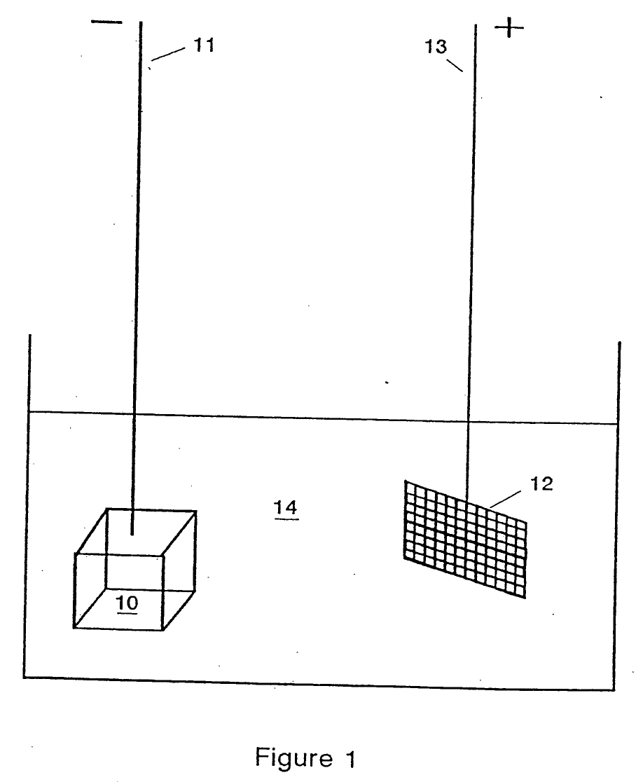

FIG. 1 depicts an electrolytic bath with a cathode (10) made of an electrical conductor, a negative pole (11) of a direct current source, an anode (12) made of platinum or another noble metal, or other materials unimpeachable in anodic conditions, and a positive pole (13) of the source. The electrolyte (14) is an ionic solution with an acidic pH in water (H₂O) or heavy water such as D₂O or T₂O.

The decomposition of water through electrolysis was observed and described first by Troostwyk and Deiman in 1789. At that time the only electrical generators were either static or frictional providing high voltage and low amperage, but not continuous current. Volta's discovery of the battery in 1800 remedied this glaring need. One month after Volta's publication, Carlisle and Nicholson published the results of the electrolysis of water using different solutions and electrodes. Since then, thousands of scientists have shown that many factors influence the hydrogen evolution reaction. It has been well known for years that any metal, alloy or other electrical conductor may function as the cathode of an electrolytic apparatus. It is also well known that such a cathode will attract positively charged particles in the bath, such as HDT+ and positively charged ions. It has generally been believed that the HDT+ attracted to the cathode remained at the outer surface of the cathode to produce molecular hydrogen according to the electrochemical mechanism:
H⁺+e⁻->H+13.5 eV (first electrochemical step)
H+H⁺+e⁻>H₂+17.8 eV (second electrochemical step)

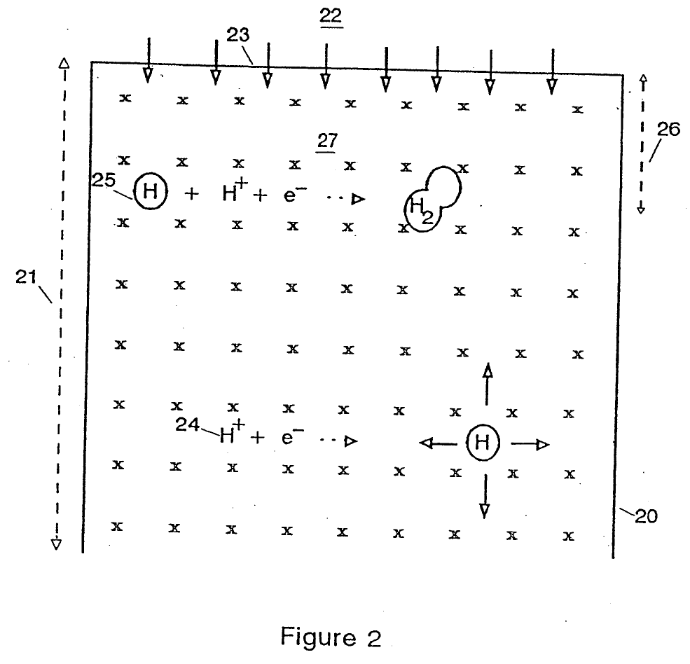

But, as shown in FIG. 2, the first step of the hydrogen mechanism is produced inside electrode 20 in layer 21, 3000 Å to 5000 Å thick (or more), including the surface atoms. The size of the HDT+ is about 10⁻⁵ Å. Compared to the size of other ions (1 Å to several Å), and the interatomic distance at the surface of the metal (more than 1 Å), the size of the HDT+ is very small. This explains why HDT+, if endowed with enough energy, can easily penetrate the electrode. In solution 22, the HDT+ particles are in perpetual movement, passing from one water molecule to another easily. As soon as a cathodic potential is applied to the electrode, the HDT+ proceed to the surface of the cathode. The first HDT+ to come in contact with the cathode reacts with electrons to become atomic hydrogen, and remain for a little while at the surface. During the second electrochemical step, the atomic hydrogen then reacts with another electron and another HDT+ to become molecular hydrogen. The time interval (dt) needed to conclude the two electrochemical steps is short, but much longer than the time interval needed by the other HDT+ to penetrate inside the electrode. Because of the electric field generated, the free HDT+ react with electrons. However, because the atoms of the surface are already occupied by hydrogen atoms, the free HDT+ can not extract electrons from the surface atoms. The free HDT+ penetrate through the surface of the metal 23 and, as soon as the free HDT+ encounter a free reactional site under the surface, react 24. The thickness of layer 21 depends on the potential applied at the electrode, if the potential is not too cathodic. For very cathodic potentials, the thickness of the layer reaches a limit comprised between 3000 Å and 5000 Å (or more), depending on the nature of the metal and the nature of the isotope (H+, D+, T+). This limit expresses the fact that the penetration of protons is impeded by the presence of numerous electrons in the metal.

The nature of the cathode exerts a very large influence on the second electrochemical step 25. For some metals, the second step occurs inside a very small layer under the surface of the electrode. For these metals, the available space in the elementary cell inside the metal is thus not large enough to contain molecular hydrogen. For a specific category of metals (e.g., platinum), the second step occurs under the surface of the electrode in a layer 3000 Å to 5000 Å thick or more. This layer is the same as the one where the first step occurs. The layers 26 for other metals are comprised between the results for the two previous categories of metal. In each elementary cell 27 of the layer where molecular hydrogen is produced, the electrochemical mechanism produces energy of 31.3 eV. The energy is used to place the metallic atoms of the layer in a state of vibration, disperse the HDT+ inside the layer and help them find the reactional sites available for reaction, disperse atomic hydrogen in the layer and inside the cathode, and, because their size exceeds the size of the free interstitial cells, displace the molecules of hydrogen outside the electrode after the reaction. The molecular hydrogen cannot penetrate the core of the electrode because it is static: this part of the electrode thus acts as a barrier which prevents the diffusion of molecular hydrogen inward. Thus, the metallic layer under the surface is an active layer which surrounds a passive metallic core. The metallic layer where molecular hydrogen is produced is dynamic, not static.

I.B. Importance of the Nature of the Cathode

The mechanism which produces hydrogen molecules by electrolysis is both an electrochemical and a physical phenomenon. The successive transformation of HDT+ into atoms, then into molecules is only a step in a very complex process where numerous physical parameters intervene. One of the most important factors influencing this reaction appears to be the available volume of free metal lattice. The free volume between the atoms of the metal can be calculated for each atom as follows:
Vfree=Va−Vreal
Va is the apparent volume of the atom
   Va=M/(ρ·N)
   where M is the molar mass of the metal, ρ is the volumic mass, N the Avogadro number, and Vreal is the real volume of the atom calculated as a sphere of atomic radius R. These calculations have showed that in fact the free volume Vfree is proportional to the apparent volume Va of the atoms, and represents about one fourth to one third of the apparent volume. For this reason, Vfree and Va are taken to be equivalent when it comes to study the influence of the metal lattice on the reaction. Va however is more interesting because it is easier to calculate even in the case where the metal is an alloy. This is why Va has been chosen to study the influence of the lattice of the cathode.

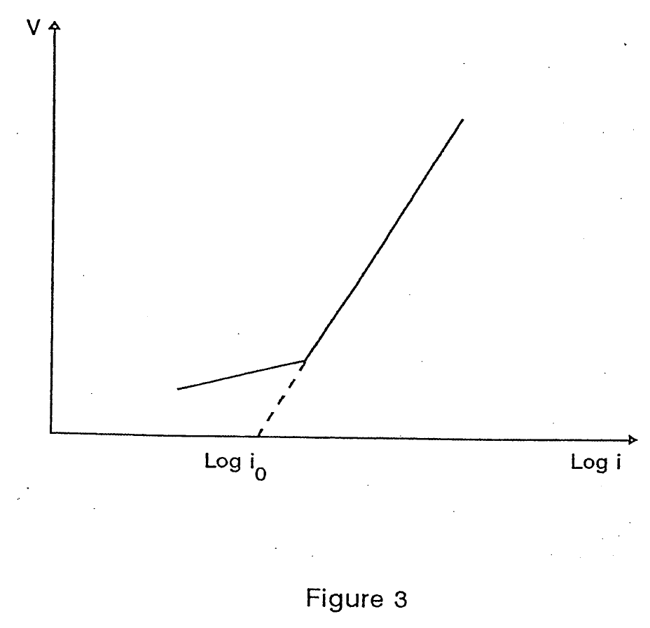

Since Tafel, the relation between current-density I and potential (V) for the hydrogen mechanism is often written as: V=a−b Log 1, where i₀, defined as the exchange current-density, equals the current at a potential equal to 0. In the literature, authors who have studied the hydrogen mechanism present their results under the form of curves V=f(log i) (FIG. 3). The current density is the sum of the current densities exchanged in the two electrochemical steps. When the potential is not very cathodic, the current-density is almost entirely caused by the first step (first slope of the curve). When the potential becomes more negative, however, the second step, slower than the first, controls the mechanism (second slope on the curve). The value of Log i₀ is obtained by reading the intersection of this second part of the curve with the axis of Log i.

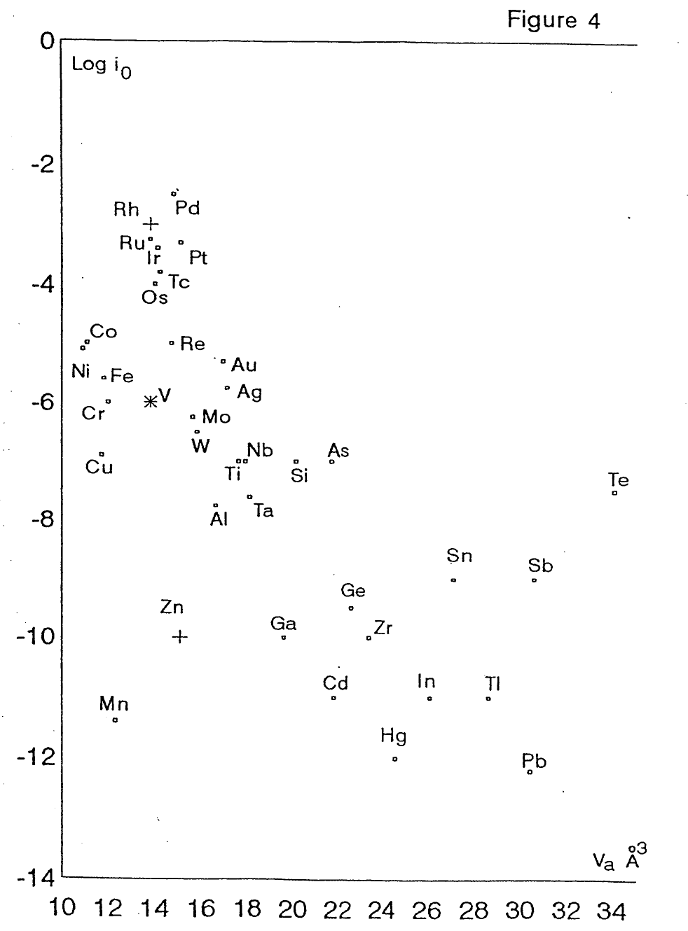

As seen previously, the second electrochemical step occurs in a layer whose thickness is directly related to the nature of the metal. This value of Log i₀ is therefore a good descriptive parameter of the second electrochemical step and is therefore related to the depth of the layer. To show the influence of the lattice of the metal, FIG. 4 presents the evolution of Log i₀ as a function of the apparent atomic volume in acid solution for all the metals studied in the literature: Ag, Al, As, Au, Bi, Co, Cu, Cd, Cr, Fe, Ga, Ge, Hg, In, Ir, Mo, Mn, Nb, Ni, Pb, Pd, Pt, Re, Rh, Ru, Sb, Si, Sm, Ta, Tc, Te, Ti, Tl, V, W, Zn, Zr.

Despite dispersion for some metals, the curve shows a general tendency: when the atomic volumes Va increase, the value of Log i₀ increases and passes a maximum. Its value for great atomic volumes is very low. The maximum of the curve is obtained for ruthenium, iridium, osmium, technetium, palladium and platinum (Va comprised between 13.8 Å³ and 15.2 Å³). The curve, however, presents numerous anomalies for metals such as copper, vanadium, manganese, and zinc. These results, apparently abnormal, are very interesting because they show that other factors intervene and allow us to understand the hydrogen mechanism more completely. Two other parameters are important: the hardness of the metal and its affinity toward hydrogen. For a given atomic volume Va, the hardness and Log i₀ are inversely proportional. The metals that have a strong affinity for hydrogen, (e.g., Zn H₂, VH_{0.71}, NbHO_{0.86}, TaH_{0.76}, TiH₂, Zr H₂), all have the lowest Log iₒ of the set for their atomic apparent volume Va. These metals' affinity for hydrogen modifies the structure of the metal and impedes the electrochemical mechanism of hydrogen production. FIG. 4 represents the first resonance phenomenon during the hydrogen mechanism: For the metals of atomic volumes V<13.8 Å³ (Ni, Co, Fe, Cr, Cu, Mn), the free available atomic volume Vfree (the free volume of the elementary cell) is too small within the metal. The reaction is possible only near the surface of the electrode where the metallic atoms can move more easily. The vibrations of the metal provoked by the energy generated by the first elementary step allow the creation of the elementary cells necessary for the second steps. For the metals whose atomic volume is comprised between 13.8 Å³ and 15.3 Å³ (Rh, Ru, Os, Ir, Tc, Pd, Pt, Re), the free atomic volume Vfree of the elementary cell is large enough for the formation of a hydrogen molecule. The two atoms H of hydrogen are created and trapped in an elementary cell whose size is only slightly greater than the size of a hydrogen molecule. The distance between the two atoms H is close to 1.2 Å, the distance of Van der Waals below which two atoms of hydrogen are forced to form a molecule of hydrogen. The energy produced through the two steps to form one hydrogen molecule is (31.3 eV). The free volume inside the elementary cell has a size of about 4 Å³ and acts as a resonant cavity for the hydrogen molecules. For the metals of atomic volumes V>15.3 Å³, the free volume of the elementary cell is much larger than the volume of the hydrogen molecule. In these elementary cells, two hydrogen atoms have enough space not to interact. As the atomic volume increases, the second step becomes more difficult to realize since the large elementary cell cannot force the two hydrogen atoms to form a hydrogen molecule. When Va increases, the value of Log iₒ decreases. A careful examination of FIG. 4 allows a determination of the factors which control the optimization of the hydrogen mechanism: an atomic apparent volume Va comprised between 13.8 Å³ and 16.4 Å³, the lowest possible hardness, and no large affinity of the metal toward hydrogen.

Knowing these factors allows for the creation of different alloys (average apparent atomic volume comprised between 13.8 Å³ and 16.4 Å³) for which the mechanism would be greatly enhanced. The metals without any affinity toward hydrogen can be divided into two groups: (Va<15 Å³, for Co, Cu, Cr, Mn, Ni, Fe, Os, Ir, Ru, Rh, etc.) and (Va>15 Å³, for Pt, Au, Ag, Mo, W, Al, etc.). Combinations of metals from these two groups which produce an average apparent atomic volume comprised between 13.8 Å³ and 16.4 Å³ allows for the reproduction of the first resonance phenomenon by creating a free volume inside the cell of about 4 Å³. Some of these alloys are: AuRh, AuRh2, AgRh2, AgRu2, CoAu2, NiAg2, FeAu2, NiAu2, but many other combinations are possible. Like the metals in the platinum metal group, these alloys facilitate the mechanism of hydrogen production. Those alloys can be used as electrodes inside fuel cells, as catalysts in the mechanisms of hydrogenation, or to eliminate pollution from vehicle-based catalytic devices.

I.C. Creation of Plasma Inside the Cathode

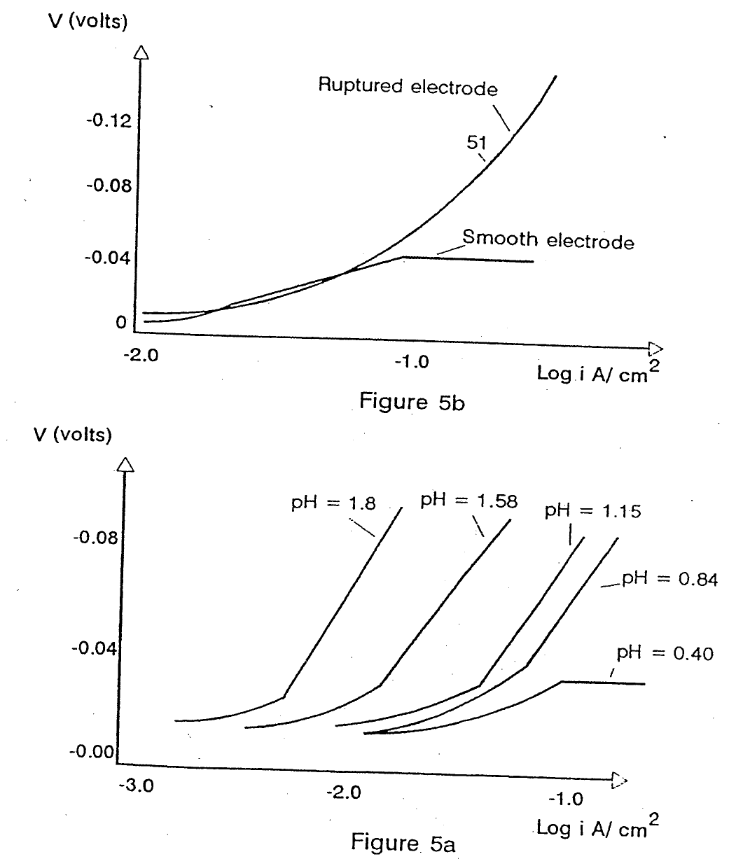

Normally, because of the affinity of palladium toward hydrogen, the Log i₀ of palladium should have a lower value, as those of vanadium, titanium, niobium, tantalum, and the like. The result appears to be incorrect. The behavior of palladium is different because its Log iₒ is close to the resonance's maximum (FIG. 4). The palladium used as a cathode at room temperature absorbs hydrogen atoms to form a beta phase where the ratio of hydrogen to palladium is equal to about 0.66. In acid solution, the behavior of the palladium cathode is very peculiar, as shown by the experiment of Clamroth and Knorr, and Schuldiner and Hoare. These experiments are summarized on curves of FIGS. 5a and 5b, which represent the potential V of the palladium as a function of Log i. FIG. 5a shows curves representing the pH range 0.4-1.8. These curves are divided into three regions. The first region, at the lowest current densities, shows a linear relationship between current density and potential. The middle region shows a linear relationship between V and Log i with Tafel b slopes progressing from 30 mV to 42 mV at pH=0.84. The third region, at the highest current-densities, also shows a linear relationship between V and Log i, but with a b slope of about 120 mV.

The more acidic solutions are also divided into three regions. The first two regions are essentially the same as the pH 0.84 curve of FIG. 5a. However, the third region, at the highest current densities, flattens out and, in this range, V is virtually independent of current density. Clamroth and Knorr claimed that this limited value of over-voltage remained constant for values as high as 80 Ampere/cm². Parameter b is equal to 0. Since bubbles of molecular hydrogen are formed on the surface of the electrode, current density should depend on potential V. In reality, it does not. As the electrochemical mechanism of hydrogen production progresses, the slope b should have a value of 40 mV. In these experimental conditions, the electrochemical steps are composed of two first electrochemical steps:

$$\begin{matrix}{H}^{+} + {e}^{-} -> H \\ + \\ {H}^{+} + {e}^{-} -> H\end{matrix} \} -> {H}_{2}$$

$$Slope b = 40 mV$$

Since it is impossible to produce hydrogen molecules with a slope (b=0), a new phenomenon must be masking the electrochemical mechanism. The palladium electrode behaves as if it was a superconductor. The metal, however, cannot transmit both elementary charges (electrons and protons). The protons, being much heavier than electrons (mprotons=1836 melectrons), are considerably more difficult to displace and are therefore much slower. The electrons can move inside the metal with a speed measured in m.s−1, while protons can only achieve speeds measured in mm.s−1. If protons could move as easily as electrons inside the metal, the protons could find a free reactional site in which to react with the electrons, and slope b would therefore be equal to 40 mV. But since the slope is nil, protons and electrons remain inside the electrode, without reacting, under plasma form. The total current-density consists of two parts: the first part consists of the two first electrochemical steps, with a slope b=40 mV, and the second part H⁺+e⁻->Plasma, where slope b=0 mV.

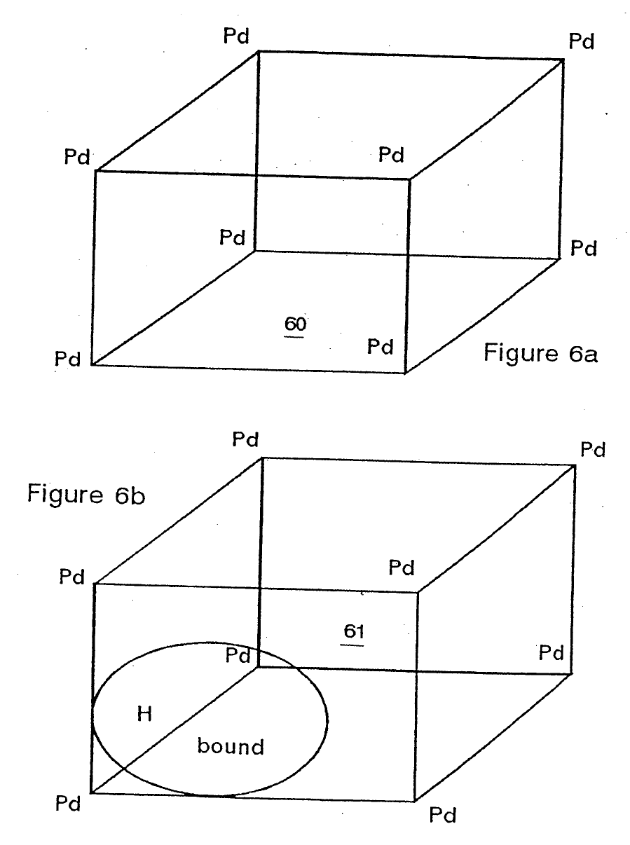

When the second part of the reaction becomes more dominant than the first, slope b is equal to 0. This new phenomenon masks the effect of the electrochemical mechanism (first part), for large current densities and pH<1, more particularly pH<0.84, preferably≦0.40. The palladium stores the plasma, whose concentration increases with time. The structure of palladium explains the formation of plasma. The palladium cathode is made of PdH_{0.66}. Two thirds of the palladium atoms are bound with one hydrogen atom. The remaining third are completely free to react. Therefore, there are two categories of elementary cells (presented in FIG. 6). To simplify the drawing, the cell is represented as if the palladium were cubic in shape.

The first category 60 is that of the elementary energy cells. There is no hydrogen atom bound to a metallic atom inside this kind of elementary cell. The volume of the cell is completely available for the electrochemical mechanism:
2H⁺+2e⁻->H₂+31.3 eV

Energy of 31.3 eV is produced with each hydrogen molecule. The energy only appears in this kind of elementary cell, hence the name elementary energy cell. The energy created inside the electrode is transmitted to the protons that are dispersed in all directions inside the electrode, the hydrogen molecules in the form of kinetic energy which helps them depart the electrode and the palladium atoms, which receive the energy by impulse.

The second category 61 is that of the elementary plasma cell. These cells have one hydrogen atom bound inside, and represent two thirds of all existing elementary cells. In the elementary plasma cells, the volume available is approximately equal to the volume of a free hydrogen atom. It is thus impossible to realize the second electrochemical step inside the elementary plasma cells because there are too many protons inside the elementary cell and because the palladium atoms are always in a state of vibration caused by the elementary energy cells. The cells are always experiencing a rapid movement of compression-expansion. The vibrations thus forbid the combination of the HDT+ and of the electrons inside the cell. The particles remain in their plasma form. The elementary plasma cell has a free available volume of about 2 Å³ that acts as a resonant cavity for the hydrogen atom. This is the second resonance phenomenon.

However, with extensive cathodic polarization and low pH solutions, a plasma overcharge can result, creating deep pits, cracks and blisters on the electrode. FIG. 5b reproduced from Hoare and Schuldiner shows in that the electrodes 51 that underwent such a treatment lose their property to produce b=0. These cracked and pitted electrodes cannot be used to create plasma inside the layer. The true cause of these microcracks, deep pits and blisters is that the electrochemical reaction is produced inside the electrode. The formation of the hydride PdH_{0.66} provokes a distention of the metallic lattice of the cathode. Then the impulses that occur every time a hydrogen molecule is created produce vibrations inside the metal. If the vibrations are disorderly and anarchic, they cancel each other. But with time, the impulses become more or less synchronized. The effect of the impulses and of the vibrations is cumulative. The compressions and extensions of the elementary cells increase to large degrees, and the metal fatigue produced by these large amplitude variations creates cracks in the metal. When there are many cracks on the surface, the vibrations can only propagate in some small parts of this surface. The cumulative effect of the vibrations and the plasma inside disappear.

Understanding this second resonance phenomenon allows other elements having the same properties (size and affinity toward hydrogen)—such as vanadium (Va=14.2 Å³), zinc (Va=15.3 Å³)—to be found, or alloys that duplicate this property to be created. The alloys preferably possess a resonant cavity or free available volume inside the elementary cell comprised between 1.75 Å³ and 2.5 Å³ or an average apparent atomic volume between 13.8 Å³ and 16.4 Å³. The cavity has the size and shape to accommodate not more than one hydrogen atom. But because of the vibrations of the metal and the excess of HDT+ in the cavity, the HDT+ and electrons inside the free volume remain in the form of plasma. It is possible to build this particular cavity inside alloys by several means: The first means is to duplicate the structure of palladium. The alloys present the first resonance phenomenon property and produce the hydrogen molecule already described (available free volume in the elementary cell comprised between 3.75 Å³ and 4.5 Å³). At least one of the metals composing the alloy presents an affinity toward hydrogen so that the alloy presents an affinity toward the hydrogen as well. The alloys are a combination of:
elementary cells free of hydrogen and available for the hydrogen electrochemical mechanism. These elementary cells, which have the size required by the resonance (14.9 Å³) and a free internal volume of about 4 Å³, allow the production of hydrogen molecules and of an energy of 31.3 eV by elementary reaction. The produced energy causes the vibrations of the plasma and of the metallic atoms. These elementary cells are the “energy cells.”
elementary cells with one hydrogen atom bound to one metallic atom. The remnant of the volume of the elementary cell is about 2 Å³; The shape of this free volume is adequate to contain one free hydrogen atom. Through the mechanical vibrations of the metal, the remainder of the cell acts as a resonator for the proton, and prevents the proton from reacting with an electron. These elementary cells are “plasma cells” since they allow a high density of plasma to be obtained in a small volume.

These specific materials, entirely or almost entirely composed of plasma cells, have a very special relation with hydrogen and exhibit exceptional properties.

II. Hydrogen Ordering Materials (H.O.M.) (Hydrom)

As shown in the previous paragraph, these materials contain one hydrogen atom bound to one metallic atom inside each and every one elementary cell. These hydrogen atoms bound inside the cells are of a size which depends on the nature of the metal. The hydrogen atoms are stored in a structured, organized, non random manner. The elementary cell is divided in exactly two sections. The bound hydrogen atom occupies the first section. The remaining free volume inside the elementary cell (second section) is about the size of a free hydrogen atom. This arrangement is reproduced exactly in each and every elementary cell. The material constitutes an interconnected tri-dimensional network of elementary free spaces, each about the size of a free hydrogen atom. Because of this unique structure, free hydrogen atoms can easily move in orderly manner into and within these hydrogen ordering materials. These hydrogen ordering materials will henceforth be referred to as H.O.M or hydroms. Hydroms have the special property of spatially and structurally ordering both the hydrogen atoms bound inside the cells and the flows of freely moving hydrogen atoms.

To create these particular materials, several conditions are considered, including but not limited to the size of the elementary cells and the affinity of the material toward hydrogen.

II.A. Size of the Elementary Cell

The size of the free volume inside the elementary cell depends on the size of the hydrogen atom bound inside. To cover the range of the different sizes of the bound hydrogen atom (small or large), the volume of the average apparent atomic volume Va of the cell is generally included between 13 Å³ and 17 Å³. However, functional cells with larger or smaller volumes are also possible. This range of particular sizes can be obtained by creating special alloys. Taking the size. Va of the palladium atom (14.7 Å³) as reference, the elements necessary to create the alloys can be divided in two categories. In the first category, the elements have an apparent atomic volume Va inferior or equal to 14.7 Å³. These elements include Be, B, C, V, Cr. Mn, Fe, Co, Ni, Tc, Ru, Rh, Pd, Os, and Ir. In the second category, the elements have an apparent atomic volume Va greater than 14.7 Å³. The second category includes Li, Na, Mg, Al, Si, P, S, K, Ca, Sc, Ti, Cu, Zn, Ga, Ge, As, Se, Rb, Sn, Y, Zr, Nb, Mo, Ag, Cd, In, Sn, Sb, Te, Cs, Ba, La, Hf, Ta, W, Re, Pt, Au, Hg, TI, Pb, Bi, Po, Fr, Ra, Ac, Ce, Pr, Nd, Pm, Sm, Eu, Gd, Tb, Dy, Ho, Er, Tin, Yb, Lu, Th, Pa, U, Np, Pu, and Am.

The combination of one or several elements from the first category with one or several elements from the second category allows the creation of alloys with an apparent atomic volume Va generally between 13 Å³ and 17 Å³ (but sometimes outside this range). This covers the different kinds of hydrogen ordering materials. In the case of a smaller sized bound hydrogen atom it is also possible to only combine elements from the first category to obtain a cell of the correct volume. Combining elements from the second category allows elementary cells with the volume needed when the bound hydrogen is of a larger size to be obtained. The size of the interstitial volume of an alloy is a function of the combination of the component elements. It is easy to determine. The size of the free interstitial volume within a plasma cell with a hydrogen atom bound inside is more difficult to determine because the size of the hydrogen atom bound to the metallic atom depends on the nature of the metal and on its affinity towards hydrogen.

II.B. Metal Hydride

Almost all metals or metalloids form a compound (metal hydride) in which hydrogen is bonded chemically. There are three categories of metal hydride compounds: ionic, covalent and metallic. The classification is based on the predominant character of the metal-hydrogen bond. This classification is somewhat imprecise since no compound exhibits one type of bonding exclusively.

The first category of ionic hydrides includes compounds in which the hydrogen is essentially ionic and forms a hydride ion H⁻. The hydride ion has a radius of approximately 1.4 Å³. These ionic hydrides are produced when the difference in Pauling's electronegativity X between the hydrogen and the metal is large. Example metals are Li, Na, K, Rb, Cs, Ca, Sr, Ba, and Ra.

The second category covers the covalent hydrides. With these compounds, an electron pair is shared between the hydrogen atom and the atom of the other element (metal or metalloid, such as Al, Si, Sb, Zn, Cu, P. As, Sn, Pb, Ge, Ga, Bi, Se, In, B, Be, Tc). With these compounds, hydrogen is considerably smaller (radius of about 0.3 Å³) than in the case of the ionic hydrides.

The third category covers the metallic hydrides or transition metal hydrides. Hydrogen inside these metals is neither a discrete proton nor an anion. Upon entering the metal lattice, there are substantial changes in the electronic bond structure. Simply put, electrons are added to empty states near the fermi level while there is simultaneous increase in electron density about the interstitial hydrogen atom. In a sense, the interstitial H atom exhibits both anionic and protonic characteristics. This category covers metals which have more or less affinity toward hydrogen. This affinity is directly related to the Pauling's electronegativity of the element. The smaller the Pauling's electronegativity of the element, the larger the affinity of the element toward hydrogen is. The electronegativity of the element also factors on the size of the hydrogen bound inside. When the Pauling's electronegativity of the element diminishes, the ionic characteristic of the bond between the hydrogen atom and the element increases, which causes an enlargement of the size of the bound hydrogen atom. These elements can be subdivided into two groups:

The first group includes Sc, Ti, V, Cr. Mn, Y. Zr, Nb, Lanthanides, Hf, Ta, W, Ac, Th, Pa, U, Np, and Pu. The Pauling's electronegativity of these elements ranges between 1 and 1.7. These elements have high affinity toward hydrogen. The hydrogen atoms bound to these elements are of a large size.

The second group includes Fe, Co, Ni, Mo, Tc, Ru, Rh, Pd. Re, Os, Ir, Pt, and Hg. For these elements, the Pauling's electronegativity ranges between 1.7 and 2.28. The affinity of these elements toward hydrogen is smaller. The hydrogen atom bound in the lattice is smaller than the one described in the previous subgroup.

In conclusion, this category covers metal with very diverse range of affinity toward hydrogen. The size of the hydrogen bound inside decrease continuously starting with the Lanthanides (Pauling's electronegativity X≅1) all the way down to Rh, Pd (Pauling's electronegativity X≅2).

II.C. Essential Requirements for the Creation of a Hydrogen Ordering Material

The size of the hydrogen atoms bound inside the lattice depends on the nature of the element with which it is associated. This property bears large implications when it comes to choosing the elements and the composition of the alloys needed to create a functional hydrom. When the elements chosen to create an alloy have a large Pauling's electronegativity X, the material created has a small affinity toward hydrogen. Thus, the hydrogen atoms bound in the lattice are of a small size. Under these conditions in order to produce a free interstitial volume of the size of a free hydrogen atom, it is necessary to reduce the size of the apparent atomic volume Va of the alloy to the lowest values of the (13 Å³-17 Å³) range, or even below this range.

When the elements chosen to make the alloy have a small Pauling's electronegativity X, the hydrogen atoms bound inside the lattice are of a larger size. Thus to create a hydrom, the size of the elementary cell must be made larger (high value of the 13 Å³-17 Å³ range, or even above this range) so as to create a free interstitial volume of the size of a free hydrogen atom. The creation of a hydrom made up only of elements which produce covalent hydrides is very difficult to achieve if not outright impossible. In the case of these elements, the bound hydrogen atoms are very small. Consequently, the size of the elementary cells of the alloy must also be very small so as to adjust the remaining volume to the size of the free hydrogen atom. Some elements such as Ag, Au, and Pt have a large Pauling's electronegativity X. They have very poor affinity toward hydrogen. If one of these previous elements is combined to create an alloy with an element of feeble affinity toward hydrogen like Ru, Rh, Ir, and Os, the resulting material does not have affinity toward hydrogen. Even if the resulting alloy respects all the other conditions necessary to create a hydroms, the materials attract very few hydrogen atoms and are not useful. To produce a hydrom using one of the elements (e.g., Ag, Au, Pt). the element is combined with elements having a smaller Pauling's electronegativity X such as vanadium, chromium, and the like. However, the behavior of an alloy made up of constitutive elements with very different Pauling's electronegativity numbers is more complex. It depends not only on the electronegativity of each element but also on the relative importance of each of these elements within the alloy. The study of these alloys will be presented later.

II.D. Properties of the Hydrom

When a hydrom ordering material is perfectly constituted, each elementary cell of the lattice is exactly divided in two sections: (a) one hydrogen atom bound to one element atom of the elementary cell occupies the first section; and (b) the remaining volume inside the elementary cell is about the size of a free hydrogen atom and constitutes the second section. These particular materials or hydroms have the unique property of spatially and structurally ordering both the hydrogen atoms bound inside and the flow of free hydrogen atoms. The free elementary volume inside the cell (the size of a free hydrogen atom) gives the hydrom several properties:

This uniquely constructed free space (resonant cavity for the free hydrogen atom) is perfect to store plasma solid. By causing this hydrom to vibrate under very special conditions (material as cathode, shape of the material, environment of the material, acid solution pH<1 . . . ) It is possible to force a large quantity of HDT⁺ into the hydrom. A part of the entering HDT⁺ reacts with electrons to become hydrogen molecules. These molecules then depart the metal. Another part of these hydrogen atoms establish a bond with the metal atoms inside the lattice. The hydrom is thus rapidly filled with bound hydrogen atoms.

The last part of the entering HDT⁺ remains in the form of plasma. Hydroms are uniquely structured to store a large quantity of hydrogen in the form of plasma (HDT⁺ and e⁻). This plasma can be used in many different applications (e.g., storage of energy, storage of matter, plasma solid fusion, transmutation). The hydrom constitutes an interconnected tri-dimensional network of elementary free spaces, each about the size of a free hydrogen atom. Because of this unique structure, free hydrogen atoms can easily move in orderly manner into and within the hydrogen ordering materials. The diffusion of free hydrogen atoms is ordered, non random and not chaotic. In any material that does not exhibit the properties of a hydrom, the diffusion would be highly chaotic. Because of their particular structure, the hydroms can be charged very quickly with hydrogen atoms.

The hydrogen atoms found in the elementary cells create other properties: The hydrogen atom bound in the elementary cells fit closely if not exactly the size and shape of the elementary space of the elementary cell that they occupy. Because they fit the volume closely if not perfectly, the mechanical stress exercised on the material is very feeble. There is no embrittlement of the material. This form of storage does not stress either the bound hydrogen atoms or the hydrom. The quantity of hydrogen which can be stored under atomic form is about 6 to 7×10²² atom/cm³ of material, the same quantity as in liquid hydrogen. The rapidity of the release of the hydrogen atoms stored inside the hydrom depends on the strength of the bond of the hydrogen atom to the metallic atom. The greater the Pauling's electronegativity X of the elements constituting the alloys, the feebler the affinity toward hydrogen will be. The hydrom can release the hydrogen atoms quickly. On the other hand, if the Pauling's electronegativity X of the elements of the alloys is small, the bond of the hydrogen atom to the metal atoms M is strong. Since there is no mechanical stress on the bound hydrogen atom and the bond M-H is strong, the release of hydrogen from the material is very slow (some cm³ of H₂/cm² of surface per day). By varying the Pauling's electronegativity X of the hydrom, it is possible to vary and control the speed of the release of hydrogen.

II.E. Resonance of the Hydrom

As seen previously, the electrochemical mechanism of production of H₂ is located in a small layer under the surface of the cathode. A large part of the hydrogen produced during the time t₁ of the electrochemical reaction exits the cathode. But the remaining part of the hydrogen atoms can be absorbed by the metal. Once the reaction is stopped, these absorbed atoms are progressively released by the cathode during a time interval t₂. The length of this time interval t₂ actually measures both the quantities of absorption of the material used as cathode and the strength of the bond of the hydrogen atoms to the metal atoms. By applying rigorously this study method to different kind of alloys under identical experimental conditions (t₁ time of electrochemical reaction, chemical solution, temperature, platinum anode, surface of cathode, volume of cathode, cathodic current density, . . . ), it is possible to measure the different time intervals t₂ for the release of the absorbed hydrogen. This time interval t₂ allows the deduction and comparison of the varying properties of these materials toward hydrogen in function of the nature of the component elements and the composition and apparent atomic volume of the alloys.

a) Alloys of Elements of the Metallic Hydride Category

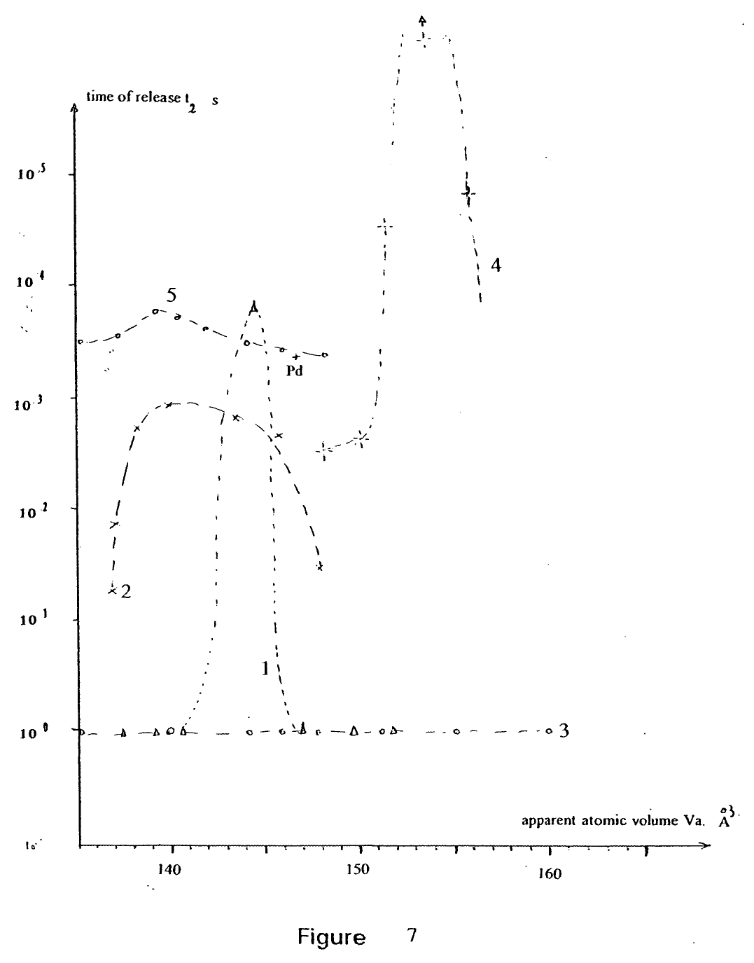

Curve 1 of the FIG. 7 presents a typical evolution curve of the time of release t₂ as a function of the apparent atomic volume Va of the alloys. The alloys on this curve are a combination of only two elements chosen from the metallic hydride category. They have about the same Pauling's electronegativity (>1.7). The varying proportions of the two elements in these alloys allow the study of materials with a wide range of apparent atomic volume Va. Curve 1 displays a sharp maximum for a value of the apparent atomic volume Va equal to 14.45 Å³. This particular alloy is a hydrom whose spatial ordering properties allow the quick absorption of hydrogen. The difference between this alloy and the other alloys on the curve is remarkable. For the alloys with an apparent atomic volume Va inferior to 14.45 Å³ the interstitial space is too small to allow the absorption of hydrogen atoms. For the alloys with an apparent atomic volume Va superior to 14.45 Å³ the interstitial space is large enough for the penetration of hydrogen atoms. But the absorption is disorganized and completely chaotic. Hydrogen atoms penetrate with very great difficulty inside these alloys. The absorption of hydrogen is negligible.

When the elements composing the alloys have a smaller Pauling's electronegativity, the affinity toward hydrogen of the alloys increases. The curve of resonance is thus modified:
The resonance occurs for higher apparent atomic volume Va. This expresses the fact that the hydrogen atom bound in the elementary cell is larger. Consequently, at resonance, the elementary cell also must be larger.
The height of the curve when at resonance is larger. This translates the fact that at resonance the material with greater affinity for hydrogen absorbs the hydrogen atoms more quickly. The release of hydrogen atoms is also slower. This explains why the time interval t₂ of release increases.

When the alloy is a combination of two elements A (high Pauling's electronegativity X) with B (low Pauling's electronegativity X), the behavior of the alloy is more complex. The relative importance of each element in the alloys has a large influence on the final outcome. If one of the elements is predominant inside the alloy, this element imposes its electronegativity to the whole alloy. The other element has a small influence. In some instances, for some combinations of specific elements with very different electronegativity numbers, it is possible to observe two resonances. The alloys where element A is predominant have a resonance in the low range 13 Å³ of the apparent atomic volume or lower. Another group of alloys where element B is predominant shows a resonance in the high range 17 Å³ of the apparent atomic volume or higher. However, one instance of resonance is generally the norm.

Curve 2 on the FIG. 7 presents the study of alloys of silver combined with another element with an electronegativity X superior to 1.7. The alloys have little affinity toward hydrogen and the height at the maximum at resonance is small. These alloys absorb very few hydrogen atoms.

b) Alloys Composed of Elements from the Covalent Hydride Category

Curve 3 of FIG. 7 presents the results obtained with alloys constituted from elements which produce covalent dihydrides. For these alloys, the curve is flat. There is no absorption of hydrogen. The bound hydrogen atoms inside the material are too small. The free interstitial space inside the elementary cells remains larger than the size of the free hydrogen atom. Because of this larger size, several hydrogen atoms can attempt to enter the same elementary cell simultaneously, which impedes the overall process. The penetration of hydrogen is disorganized and chaotic. The absorption of hydrogen is thus rendered negligible.

Some elements produce covalent hydrides with three or four bound hydrogen atoms. Some of the alloys made from these elements are hydroms (hydrogen ordering materials). Some combinations of elements that produce covalent hydrides with three or four bound hydrogen atoms with elements that produce dihydrides will also produce hydroms. The resonance of the hydroms produced by combining elements from these two categories is found around 13 Å³ and lower. In these alloys, a greater number of small bound hydrogen atoms inside the cell allows for the formation of a free volume equal to the volume of a free hydrogen atom.

c) Alloys Composed of one Metallic Hydride Element and one Covalent Hydride Element

Curves 4 and 5 on FIG. 7 present the study of 2 kinds of alloys. The two different kinds of alloys are both constituted with an element producing a metallic hydride and an element producing a covalent hydride. Both curves 4 and 5 present a resonance maximum, just as curve 1 and 2 did. But unlike the resonance maximum for the metal hydrides in Curves 1 and 2 which is very sharp, the resonance maximum for the Metal Hydride-Covalent Hydride alloy combinations is wide. It is possible to have absorption of hydrogen atoms for a large range of apparent atomic volumes. Apparently, the size of the hydrogen atoms bound inside the lattice varies in direct relation to the apparent atomic volume Vₐ of the alloy. Another possible explanation is that the increase of the volume Vₐ and the enlargement of the elementary cell cause the covalent hydride element to progressively bond with more than one small hydrogen atom.

d) Alloys Containing Elements Producing Ionic Elements

The elements producing ionic hydrides have a low Pauling's electronegativity. The hydrogen atoms bound to these elements are large. Certain combinations of elements that produce ionic hydrides with elements that produce metallic hydrides, or with elements that produce covalent hydrides, will also allow the creation of Hydroms. But the size of the elementary cells in these types of hydroms is large, and is often larger than 17 Å³.

In conclusion, depending on the electronegativity and the nature of the elements combined, it is possible to create alloys whose specific combination makes them perfect hydroms. These hydroms alloys absorb and retain hydrogen atoms very efficiently. Alloys containing more than two elements are also possible. Each element in these materials contributes its own characteristics. The hydroms can also be used under the form of monocrystal to further improve the ordering properties of the material.

II.F. Variation in the Position of the Resonance Vₐres in Function of the Pauling's Electronegativity of the Alloy

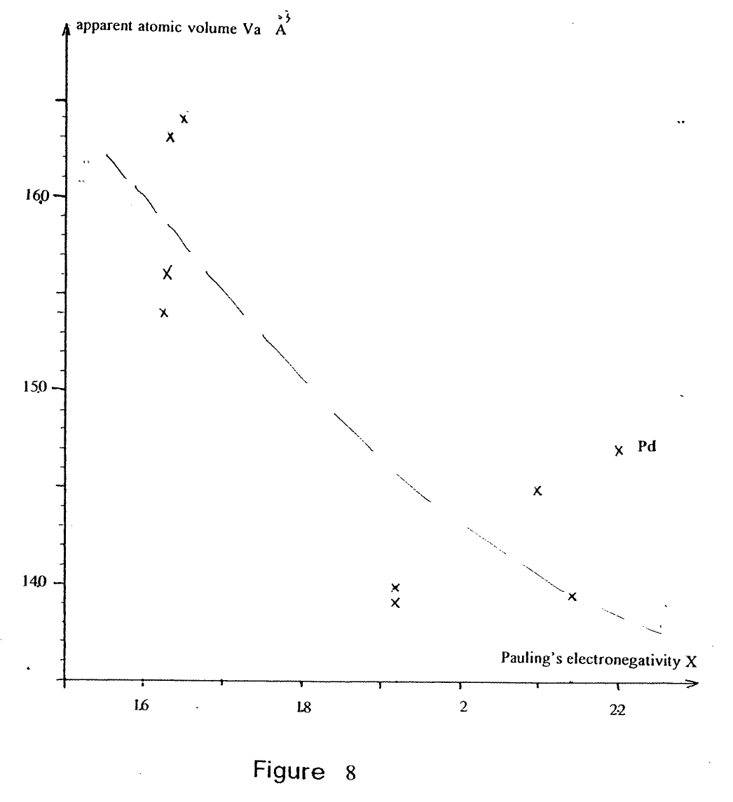

FIG. 8 presents the variation of the apparent atomic volume Vₐ of the hydroms as a function of the Pauling's electronegativity number of the alloys. In other words, the curve in FIG. 8 displays the range of apparent atomic volume of the different alloys at the maximum of resonance in function of their Pauling's electronegativity. The determination of this electronegativity was accomplished by averaging the electronegativity of the elements weighed by their respective atomic percentages within the different alloys. The curve shows the correlation between the apparent atomic volume Vₐres and the electronegativity of the different hydroms. The greater the electronegativity of the alloys, the smaller Vₐres is. This reflects the fact that the hydrogen atoms bound inside these materials are smaller. Accordingly the elementary cell must also be smaller to create a free elementary space of the size of the free hydrogen atom. On the other hand, when the electronegativity of the alloy is small, the value of Vₐres is high. This translates the fact that with a high electronegativity, the bound hydrogen atoms are bigger. Consequently, the elementary cells inside the hydroms are also larger to create a free internal space of the size of the free hydrogen atom.

II.G. Palladium: Nature's Exception

Generally, the electronegativity determines the reactivity of the elements toward hydrogen. The greater the difference in electronegativity between the hydrogen and the element, the greater the reactivity of the element toward hydrogen will be. The relationship explains why this reactivity toward hydrogen decreases progressively from the group IV A (Ti, Zr, Hf) down to the group VIII A (Ni, Pt). The only exception to this rule is Palladium (Group VIII A) which readily absorbs hydrogen to the limit PdH_{0.66}. Palladium is an exception of nature. This phenomenon is very surprising because the Pauling electronegativity number of Pd is 2.2, the same as hydrogen. There is no electronegativity difference between the two elements. Consequently, the reactivity between these two elements is very feeble. The absorption of hydrogen by palladium is caused by another phenomenon entirely. Palladium is the only element which has a structure that somewhat approaches that of a hydrom. To show how palladium approximates the properties of a hydrom, the electronegativity of Pd and its apparent atomic volume Vₐ are shown in FIG. 8. The position of the Pd point while close is located slightly above the curve. This means that Pd approximates to a certain extent the hydrogen absorption properties of perfect hydroms. With an electronegativity of 2.2, the apparent atomic volume of Pd is not quite small enough to allow Pd to equal the properties of a perfect hydrom. This imperfection can be corrected by making alloys that combine Pd with smaller elements. For every single one of the distinct elements chosen to correct Pd's imperfection, a specific alloy composition will result in the creation of a perfect hydrom.

The release of hydrogen from Palladium has been studied under the same conditions as the experiences presented in FIG. 7. The result for Pd is also indicated on FIG. 7. The curve demonstrates both the imperfection of Pd, and the way it approximates the properties of a perfect hydrom. The comparison between the results for Pd and the results for the hydroms on the curve show that hydroms are much better at absorbing and retaining hydrogen than Pd.

III. Applications of the Hydroms

The remarkable properties of absorption, retention and release of hydrogen by the hydroms open the way to vast fields of applications.

III.A. Media of Application

The hydroms can be used in very diverse media (solid, liquid, any kind of solutions, acid, basic, neutral, organic, gas . . . ) and very diverse environments (high or low temperature, high pressure, vacuum, high radiation . . . ). Whatever the need, be it high retention of H₂, quick release of H₂, high temperature environment, etc. . . . the large variety of elements that can be used to create perfect hydroms insures that a situation specific solution will always be found. Some environments can be very aggressive or corrosive. For these particular media, the surface of the hydroms can be protected by a layer of Pd or alloys of Pd with hydrom-like properties. Another possibility is to create the hydroms out of elements which make the alloy unimpeachable in these particular media.

III.B. Plasma Solid

The elementary cells inside hydroms have a free volume of about the size of a free hydrogen atom. These flee spaces are ideal to create and accumulate plasmas of protons, deuterons or tritons HDT⁺. This plasma of particles inside the solid is very stable and can reach high densities (10²² to 10²⁴ HDT⁺/cm³ of solid). The plasma solid can be used to store energy and store matter, as a source of energy, as means of propulsion in space, for plasma solid nuclear fusion, for plasma solid transmutation, or any number of other applications. The movement of the plasma inside the hydroms is very efficient. Transmission of plasma to, from and inside these hydroms is easily achieved.

III.C. Applications Linked to the Quick Release of Hydrogen Atoms Inside the Hydroms

Perfect hydroms have the special property of ordering hydrogen in a tri-dimensional lattice structure. The material is an ordered tri-dimensional network of free volumes of the size of a free hydrogen atom. This structure is very conducive to the easy orderly diffusion of hydrogen atoms. The diffusion is both very rapid and specific to hydrogen atoms. This remarkable property can be used for:

(a) the separation of hydrogen atoms from a mixture of gases. Only the hydrogen will be able to penetrate and diffuse inside the hydrom. The diffusion is rapid. The separation of the hydrogen from the other gases is thus equally rapid.

(b) the purification of hydrogen. When hydrogen is polluted by small quantities of other gases, it is possible to use the method described above to purify it. Through diffusion inside a hydrom, the hydrogen is purified. The other gases remain outside the hydrom, while the hydrogen passes through to the other side of the material.

(c) isotopic separation of hydrogen atoms HDT. In free form, the different isotopes of hydrogen are not exactly of the same size. This remains true when they become bound to a metallic atom. These small size differences can be used to conduct an isotopic separation of hydrogen. When a hydrom has been created specifically for the protium, the ordering properties of the material are only perfect for the protium. If the resonance of this specific hydrom is very sharp, the ordering properties of the material for deuterium and tritium are much weaker. The diffusion of deuterium and tritium throughout the hydrom is thus slower, which allows the isotopic separation of hydrogen.

III.D. Catalytic Property

Like Palladium, but with much better results, the hydroms can absorb and release hydrogen. The surface of the hydroms can thus behave like an exchanger of hydrogen. This explains the catalytic properties of the hydroms. These properties insure that these materials can be used as catalysts in different kinds of chemical reactions:
hydrogenation, dehydrogenation, isomerization, cyclization, dehydratation, dehalogenation, oxidation reactions . . . ;
upgrading the octane rating of gasoline by catalytically accelerating a complex series of reactions: dehydrogenation, hydrogenation, isomerization and cyclization;
catalyst for the reaction of oxidation H₂+O₂;
as cathode in the electrochemical mechanism of production of H₂;
skin to noble metals (palladium, platinum . . . see FIG. 4), all hydroms allow hydrogen to be produced using less energy than all the other materials. Because of their hydrogen ordering structure, these hydrogen ordering materials are considerably more efficient
as catalysts to reduce and eliminate vehicle (e.g., car) exhaust and other airborne gaseous pollution; and
as cathode for the isotopic separation of protium, deuterium, tritium during the electrochemical mechanism of hydrogen production.

III.E. Storage of Hydrogen

Because of their order generating properties and their electronegativity, these materials can store a large amount of hydrogen very quickly. The density of the hydrogen stored can equal that found in liquid hydrogen. The hydrogen absorbed in the alloy can be produced from any source: electrochemical reaction, hydrogen gas, plasma . . . The speed of release of the hydrogen from these hydroms depends on the electronegativity of the alloys. With larger electronegativities, the release of hydrogen is rapid. And it can be accelerated further by increasing the temperature of the alloy.

As seen previously, the hydrogen atoms inside the free volume of the material are stress free (no mechanical stress). If the hydrom has a small electronegativity number X, the bond between the metal and the hydrogen is strong. When both these factors apply, the release of the hydrogen from the hydrom is very slow (some cm³ of H₂/cm² of surface per day). The loss of H₂ being negligible, the material itself can be used as a storage tank. Using an additional pressurized tank of H₂ to prevent the hydrogen bound inside from escaping the material is not necessary. This kind of slow release storage is particularly interesting in the field of fuel cell applications.

III.E. Fuel Cells

Fuel cells are interesting for two particular reasons. First, a fuel cell is an electric cell that converts the chemical energy of fuel directly into electric energy by continuous process. Second, the efficiency of the conversion can be made much greater than that obtainable by thermal power conversion. The most successful type is the classical H₂-O₂ fuel cell. The reaction taking place at the anode is:
2H₂->4H⁺+e−
and at the cathode, the reaction is:
O₂+2H₂O->4OH—

The result of the reaction is the production of electric energy and molecules of water. The product of the reaction is non-polluting. However, several technical parameters impede the overall efficiency of the reaction. The two gases have a low solubility in electrolytes. This requires that the reaction taking place at the interface electrode-electrolyte use a large area of contact. In general, the electrodes are porous to increase the surface of reaction. And they must be made of material with very efficient catalytic properties. Additionally, storing the hydrogen in a side tank and releasing it to the electrode is also a source of great technical difficulties. Every single one of these problems can be resolved by using a hydrom anode of small electronegativity, as described in the previous paragraph.

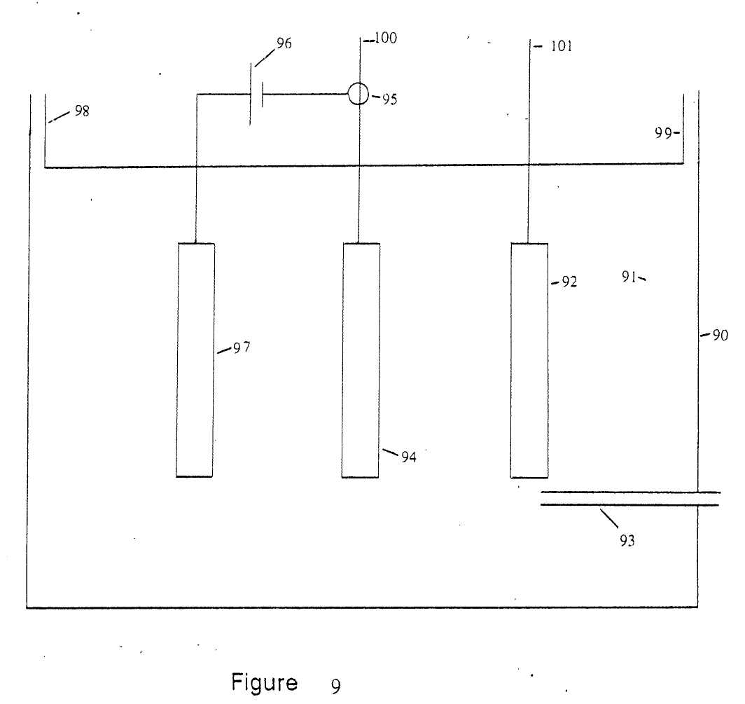

FIG. 9 presents a fuel cell using a hydrom as anode. The fuel cell is contained inside an enclosure 90 which contains electrolytic solution 91 (acidic or basic). Cathode 92 of the fuel cell is located close to entrance 93, the entry point for the oxygen gas O₂. Anode 94, a hydrogen ordering material, is used both as an electrode for the reaction and as the storage center for hydrogen. Thanks to switch 95, hydrom 94 can be connected either to the fuel cell or to a secondary circuit. The purpose of the secondary circuit is to recharge the hydrom electrode with hydrogen. To achieve this purpose, a power source 96 supplies direct current both to anode 97 and hydrom 94. In this secondary circuit, the hydrom electrode is used as a cathode. During the secondary electrochemical reaction for the production of H₂, the hydrom absorbs hydrogen atoms and binds them inside its lattice. The enclosure has two openings: opening 98 which allows the exit of the excess gas, and opening 99 for the introduction of water or electrolytic solution inside the fuel cell. The electric power to the fuel cell is supplied through connections 100 and 101.

Using a hydrom as an anode in the fuel cell resolves different technical impediments: First, the material of the anode stores the hydrogen directly. When the electronegativity of the hydrom is small, there is no need for a pressurized H₂ enclosure (as seen in the previous paragraph). Second, when used as anode, the hydrom is composed of elements unimpeachable under these chemical and electrochemical conditions. Third, the hydrogen does not need to be released quickly from the electrode. Fourth, because of its constitution, the catalytic efficiency of the hydrom is much greater than that of Pd, Pt or the other noble metals. Fifth, the conversion of the hydrogen atoms into protons occurs directly inside the hydrom. The protons resulting from the reaction can transit easily inside the hydrom because of its spatial ordering properties. These protons leave the electrode to react inside the electrolyte with the OH-ions coming from the other electrode. The requirement for anodes with large reaction areas is negated. This also solves the problem of the lack of solubility of the hydrogen in the electrolytic solution. Sixth, a fuel cell with many electrodes can also be used.

These fuel cells have many applications, including as source of energy in transport (car, truck, plane . . . ), as storage of energy, and as small batteries for cell phones, electric and electronic devices, batteries in computers . . .

By using hydroms as anode, these fuel cells can be recharged. Plugging the secondary circuit to a power source is all that is required to insure that the hydrom is reloaded quickly with hydrogen atoms.

III.F. Superconduction

With their particular structure and electronegativity toward hydrogen, the hydroms can be created from various elements chosen from the three categories of metal hydrides. Among these elements, some have special superconductive properties: Lanthane, Lanthanides, Titanium, Zirconium, Hafnium, Vanadium, Niobium, Tantalum, Molybdenum, Tungsten, Technetium, Rhenium, Ruthenium, Osmium, Iridium, Zinc, Cadmium, Mercury, Aluminum, Gallium, Indium, Thallium Tin, Lead, Silicon, Germanium, Selenium, Antimony, Tellurium, Bismuth, Beryllium, Cesium, Baryum, . . . Hydroms created with these elements as the predominant alloying components also have interesting superconductive properties. When hydroms such as the metal hydrides Th₄H₁₅ PdH_{0.66} are saturated with bound hydrogen atoms, this particular ordering structure is highly conducive to superconductivity.

III.G. Embrittlement of the Alloys Caused by the Absorption of Hydrogen

By choosing and combining two elements from the categories described in II.B., it is possible to create a range of different alloys, all with different apparent atomic volumes Vₐ. One of these alloys will be a hydrom with a specific apparent atomic V_{aH}, whose hydrogen ordering properties and internal environment are optimal. The hydrom's spatial ordering properties regulate both the hydrogen atoms bound inside and the flow of free hydrogen atoms in such a way that the internal environment is both stress-free and perfectly structured and organized. Most of the other alloys will be completely unsuitable to the absorption and storage of hydrogen. But another smaller subset of these alloys will approximate more or less closely the properties of the perfect hydrom. For these alloys which approximate the properties of a hydrom, a combination of specific factors is highly destructive. These factors can be summarized thus:
if the difference in the electronegativity between the two alloying elements is large; and
if the apparent atomic volume Vₐ of the alloy is smaller than the apparent atomic volume V_{aH} of the perfect hydrom created using the same two elements.

If the two destructive conditions described above are present, the mechanism inevitably results in the destruction of the alloy. The destruction occurs as follows. As soon as the material comes into contact with a source of hydrogen, it absorbs hydrogen. The element with the larger electronegativity allows the hydrogen atoms inside the material. Since the electronegativity of this first element is large, the hydrogen atom bound is of a small size. The bond between the hydrogen atom and the element atom is feeble. Since the other alloying element has a smaller electronegativity, it is more reactive toward hydrogen. Thus whenever the hydrogen atoms absorbed encounter atoms of the element with the smaller electronegativity number, they react and bind with it. To match the new bound, their size increases accordingly. Unfortunately, since the apparent atomic volume Vₐ of the alloy is smaller than the V_{aH} of the Hydrom created with the same elements, the volume of the elementary cell is not large enough to contain the free hydrogen atom. The internal environment of the cell is no longer stress free. This results in the embrittlement of the material and its progressive destruction downward from the surface. Crystal grains at the surface break loose and fall off from the material.

In a hydrogen environment, it is better to use alloys with the composition of hydroms, or with an apparent atomic volume Vₐ superior to the V_{aH} of the hydrom created from the same two elements. This observation holds true for alloys composed with multiple elements.

What is claimed is:

1. A method of producing hydrogen ordering materials, comprising:
providing a metal having a lattice of metallic atoms forming elementary cells; and
binding at least one hydrogen atom to the metallic atoms of the elementary cells to consume a portion of the elementary cells and establish a residual available space having a volume approximately equal to the volume of a free hydrogen atom.

2. The method of claim 1, wherein the residual available spaces of the elementary cells establishes an interconnected tri-dimensional network in which hydrogen atoms can move.

3. The method of claim 1, further comprising introducing a hydrogen atom into the residual available space.

4. The method of claim 1, wherein the metal comprises an alloy, and wherein the metallic atoms comprise first and second elements which differ from one another.

5. A hydrogen ordering material, comprising:
a metal having a lattice of metallic atoms forming elementary cells; and
at least one hydrogen atom bound to the metallic atoms of the elementary cells to consume a portion of the elementary cells and establish a residual available space having a volume approximately equal to the volume of a free hydrogen atom.

6. The hydrogen ordering material of claim 5, wherein the residual available spaces of the elementary cells establishes an interconnected tri-dimensional network in which hydrogen atoms can move.

7. The hydrogen ordering material of claim 5, further comprising introducing a hydrogen atom into the residual available space.

8. The hydrogen ordering material of claim 5, wherein the metal comprises an alloy, and wherein the metallic atoms comprise first and second elements which differ from one another.

9. A method of using hydrogen ordering materials, comprising:
providing a metal having a lattice of metal atoms forming elementary cells;
binding at least one hydrogen atom to the metal atoms of the elementary cells to consume a portion of the elementary cells and establish a residual available space having a volume approximately equal to the volume of a free hydrogen atom; and
using the hydrogen ordering material.

10. The method of claim 9, wherein the residual available spaces of the elementary cells establishes an interconnected tri-dimensional network in which hydrogen atoms can move.

11. The method of claim 9, further comprising introducing a hydrogen atom into the residual available space.

12. The method of claim 9, wherein the metal comprises an alloy, and wherein the metallic atoms comprise first and second elements which differ from one another.

13. The method of claim 9, wherein said using comprises storing hydrogen in the residual available spaces.

14. The method of claim 9, wherein said using further comprises releasing the hydrogen from the residual available spaces.

15. The method of claim 9, wherein said using comprises storage of plasma in the residual available spaces for release.

16. The method of claim 9, wherein said using comprises separation of hydrogen from a gas mixture.

17. The method of claim 9, wherein the using comprises introducing hydrogen stored in the residual available spaces into a chemical reaction as a catalyst.

18. The method of claim 9, wherein said using comprises incorporating the hydrogen ordering material into a device as a fuel cell.

19. The method of claim 18, wherein the device comprises a vehicle.

20. The method of claim 9, wherein said using comprises applying the hydrogen ordering material as a superconductor.
